(19) United States
(12) Patent Application Publication
(10) Pub. No.: US 2010/0101431 A1
(43) Pub. Date: Apr. 29, 2010

(54) Turkey fryer safety skirt

(76) Inventor: Bob Myshrall, Moultonborough, NH (US)

Correspondence Address: FRANCIS EDWARD MARINO, 394 MEREDITH NECK ROAD, MEREDITH, NH, 03253, US

(21) Appl. No.: 12/653,063

(22) Filed: Dec. 9, 2009

Related U.S. Application Data
(63) Continuation-in-part of application No. 12/284,775, filed on Sep. 25, 2008.

(51) Int. Cl. A47J 37/12

(52) U.S. Cl. 99/403

(57) ABSTRACT

In the exemplary embodiment, a device for deep fat frying turkeys and such is demonstrated having a pot with an open top, a closed bottom, and a peripheral wall surrounding the open top and extending downwardly there-from to and closed by the closed bottom. The pot defines a reservoir for containing a flammable cooking liquid. A skirt surrounds the peripheral wall and extends peripherally downwardly and outwardly there-from to an outer peripheral edge disposed outwardly beyond the pot.

### RELATED APPLICATION

This application is a Continuation-in-Part of and claims the benefit of pending U.S. Utility patent application Ser. No. 12/284775, filed Sep. 25, 2008, the entire teachings of which are incorporated herein by reference.

### FIELD OF THE INVENTION

The present invention is related to open flame deep fat frying. More specifically, the invention is related to the frying of a food items, such as a turkey, in a pot of flammable liquid over an open flame and to means for causing liquid inadvertently spilled from the pot to avoid the flame and thereby avoid dangerous ignition.

### BACKGROUND

Deep fat frying devices are well known. The term “deep fat” typically refers to a heated reservoir of liquefied fat, liquefied shortening, oil, or other similar flammable liquid, heretofore referred to generically as “fat”, that is deep enough to submerse a food item for cooking therein. During the 1990's a nationwide surge in appliances for the deep fat frying of poultry, generically referred to as “turkey fryers” took place. Such turkey fryers became very popular, especially during the holidays. Such devices are typified by the U.S. Pat. No. 6,439,107 and the device shown in prior art FIGS. 1 through 3.

Referring to FIGS. 1 to 3, such devices typically include a large open pot 100 for containing fat 102A, a frame 104 for holding the food item, such as turkey 106, during lowering into and removal from the fat, a lid 108, and a cooking stand 110 capable of providing a flame 112, usually fueled by LP or propane gas from an external supply, to the underside of the pot when the pot is positioned thereon, for heating the fat therein.

Soon after the surge in use of such turkey fryers, it became obvious that they had an inherent safety flaw. Fat, heated already to its flash point, often overflowed the pot during insertion or removal of the turkey, and oftentimes came instantly into contact with the open flame and explosively ignited. Whether such overflow was caused by placing a large-mass turkey into a pot already overfilled with hot fat and forcing the excess fat out of the pot to make room for the turkey, or whether such overflow was caused by the expanding vaporization of moisture from the raw turkey upon insertion into the hot fat, or whether such overflow was caused by the hydraulic piston-cylinder relationship of the turkey and frame with the pot during removal of the turkey from the pot, pushing the hot fat disposed above the turkey out of the pot, the result was almost always the same. As seen in Prior Art FIG. 3, the spilling hot fat 102B dripped directly towards flame 112 and explosively ignited. Resulting in numerous deaths and many serious injuries to users.

As evidence of the danger of such inadvertent ignition, Underwriters Laboratories ceased giving safety certification to any such turkey fryers in 2002. A video demonstrating the inadvertent ignition of the spilling fat may be viewed at http://www.ul.com/global/eng/pages/offerings/perspectives/consumer/productsafety/turkeys/. “UL considers turkey fryers to be dangerous to use presenting numerous safety hazards to consumers. “We're worried by the increasing reports of fires related with turkey fryer use,” says John Drengenberg, consumer affairs manager of UL. “Based on our test findings, the fryers used to produce those great-tasting birds are not worth the risks. And, as a result of these tests, UL has decided not to certify any turkey fryers with our trusted UL Mark.”

Another less recognized safety flaw in deep fat fryers is derived from their thermal inefficiencies. So much of the heat from the flame is lost up the sides of the pot that the flame intensity must be increased to produce far more heat energy that is needed to maintain the fat at cooking temperature. This increased flame intensity results in an increased flame size and results in flame tips protruding outwardly from the bottom of the pot, as seen in FIGS. 2 and 3. Such excessively protruding flame tips are more easily inadvertently dripped upon by inadvertently spilled fat, increasing the likelihood of inadvertent ignition.

There exists a need for improvement in the safety of deep fat fryers, and such is an object of the present invention. There exists the need for improvement in the prevention of inadvertent ignition of spilled fat from deep fat fryers, and such is an object of the present invention. There exists the need for improved thermal efficiency in deep fat fryers so that cooking flame intensity may be reduced, and such as an object of the present invention.

There exists a need for improvement in the safety of turkey fryers, and such is an object of the present invention. There exists the need for improvement in the prevention of inadvertent ignition of spilled fat from turkey fryers, and such is an object of the present invention. There exists the need for improved thermal efficiency in turkey fryers so that cooking flame intensity may be reduced, and such as an object of the present invention.

Further needs and objects exist, which are addressed by the present invention, as may become apparent by the included disclosure of an exemplary embodiment thereof.

### SUMMARY OF THE INVENTION

The invention may be embodied in a deep fat frying apparatus including a pot having an open top, a closed bottom, and a peripheral wall surrounding the open top and extending downwardly there-from to and closed by the closed bottom. The pot defines a reservoir for containing a flammable cooking liquid. A skirt may surround the peripheral wall and extend peripherally downwardly and outwardly there-from to an outer peripheral edge. The outer peripheral edge may preferably be outwardly beyond the pot.

The skirt may extend peripherally downwardly and outwardly from the peripheral wall in one of a straight slope, a concaved slope, and a jump-edged slope. The outer peripheral edge may include a peripheral moat. The apparatus may further include a cooking stand for supporting the pot and providing a cooking flame directed against the closed bottom. The outer peripheral edge may preferably be outwardly beyond any flame tips extending outwardly from the cooking flame. The outer peripheral edge may preferably be at least approximately three inches outwardly beyond the pot.

The invention may alternatively be embodied in a combination deep fat frying pot and skirt, the pot having an open top, a closed bottom, and a peripheral wall surrounding the open top and extending downwardly there-from to and closed by the closed bottom. The pot defines a reservoir for containing a flammable cooking liquid. The skirt may surround the peripheral wall and extend peripherally downwardly and outwardly there-from to an outer peripheral edge. The outer peripheral edge may preferably be outwardly beyond the pot. The outer peripheral edge may preferably be is at least approximately three inches outwardly beyond the pot. The skirt may extend peripherally downwardly and outwardly from the peripheral wall in one of a straight slope, a concaved slope, and a jump-edged slope. The outer peripheral edge may include a peripheral moat.

The invention may alternatively be embodied in a skirt for use in combination with a cooking pot, the skirt including a shelf extending peripherally downwardly and outwardly from the pot for deflecting outwardly any materials spilled from the pot. The shelf and pot may cooperatively form a peripheral chamber surrounding the pot and disposed below the shelf, for retaining heat against the pot. The shelf may extend peripherally downwardly and outwardly from the pot in one of a straight slope, a concaved slope, and a jump-edged slope. The self may terminates in an outer peripheral edge comprising a peripheral moat.

Further features and aspects of the invention are disclosed with more specificity in the Detailed Description, and Drawings, provided herein and showing exemplary embodiments of the invention.

### BRIEF DESCRIPTION OF THE DRAWINGS AND APPENDICES

Many aspects of the invention can be better understood with reference to the included drawings and appendices. The components in the drawings are not necessarily to scale, and all components may not be present in all views, emphasis instead being placed upon clearly illustrating the principles of the present invention. Moreover, in the drawings, like reference numerals designate corresponding parts throughout the several views.

FIG. 1 is a perspective view of an exemplary prior art turkey fryer;

FIG. 2 is a front view of the prior art turkey fryer of FIG. 1 during cooking;

FIG. 3 is a front view of the prior art turkey fryer of FIG. 1 during removal of a cooked turkey there-from;

FIG. 4 is a perspective view of turkey fryer in accordance with a first exemplary embodiment of the invention;

FIG. 5 is a cross-sectional view of the turkey fryer of FIG. 4 during cooking;

FIG. 6 is a front view of the turkey fryer of FIG. 4 during removal of a cooked turkey there-from;

FIG. 7A is a partial cross-sectional view through the straight-sloped skirt of the fryer of FIG. 4;

FIG. 7B is a partial cross-sectional view through an alternative skirt having a jump-edged slope;

FIG. 7C is a partial cross-sectional view through an alternative skirt having a peripheral moat;

FIG. 7D is a partial cross-sectional view through an alternative skirt having a concaved slope; and

FIG. 8 is a perspective view of an alternative pot and skirt for use in practicing the inventions and having a rectilinear peripheral shape.

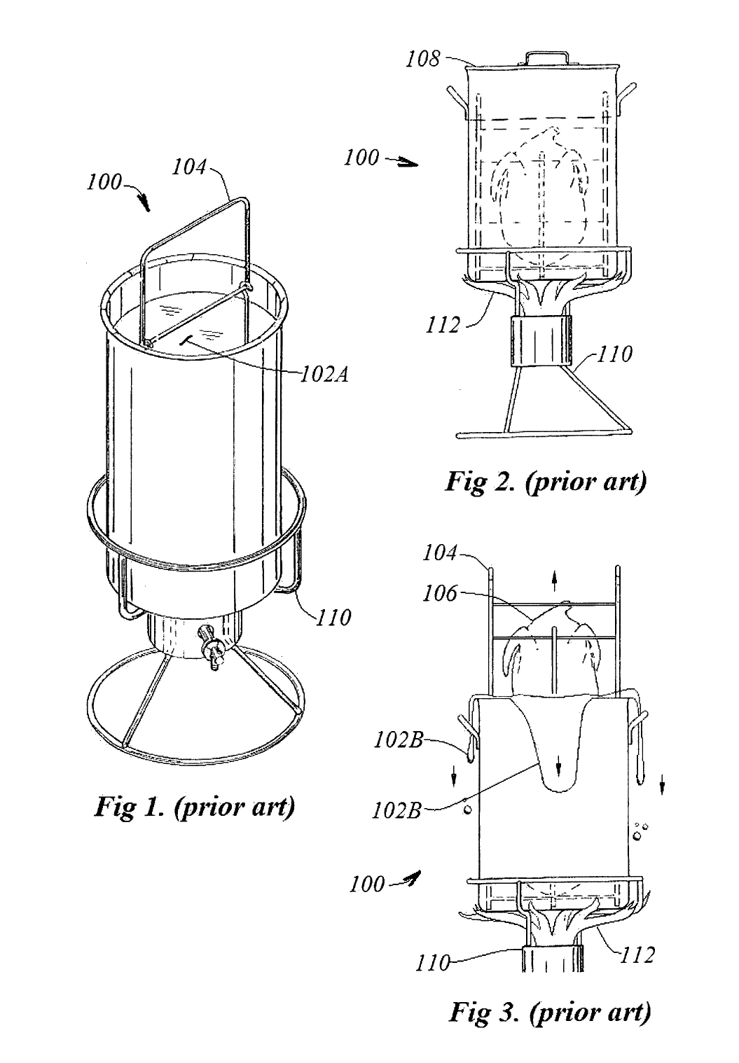

### DETAILED DESCRIPTION

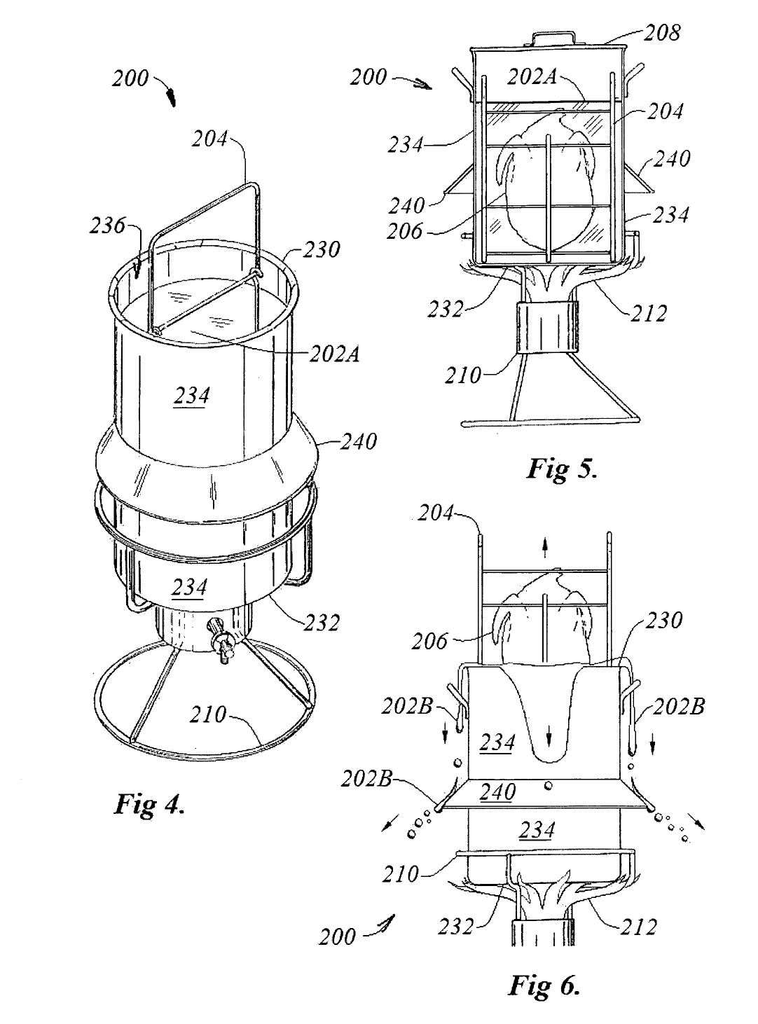

Reference is now made to FIGS. 4 through 6, where there is shown a turkey fryer 200 according to a first exemplary one of the infinite number of possible embodiments of the present invention.

The present invention provides a turkey fryer 200 include a large open pot 200 for containing fat 202A, a frame 204 for holding the food item, such as turkey 206, during lowering into and removal from the fat, a lid 208, and a cooking stand 210 capable of providing a flame 212, usually fueled by LP or propane gas from an external supply, to the underside of the pot when the pot is positioned thereon, for heating the fat therein.

Pot 200 has an open top 230, a closed bottom 232; and a peripheral wall 234 surrounding said open top and extending downwardly there-from to and closed by the closed bottom. The pot defines a reservoir 236 for containing fat 202A, which when heated forms a flammable cooking liquid. Alternatively, any ordinary shortening or cooking oily may be used. As so far described, the fryer may be any of a number of prior art fryers, including those described in U.S. Pat. No. 6,439,107, the entire teachings thereof being incorporated herein by reference.

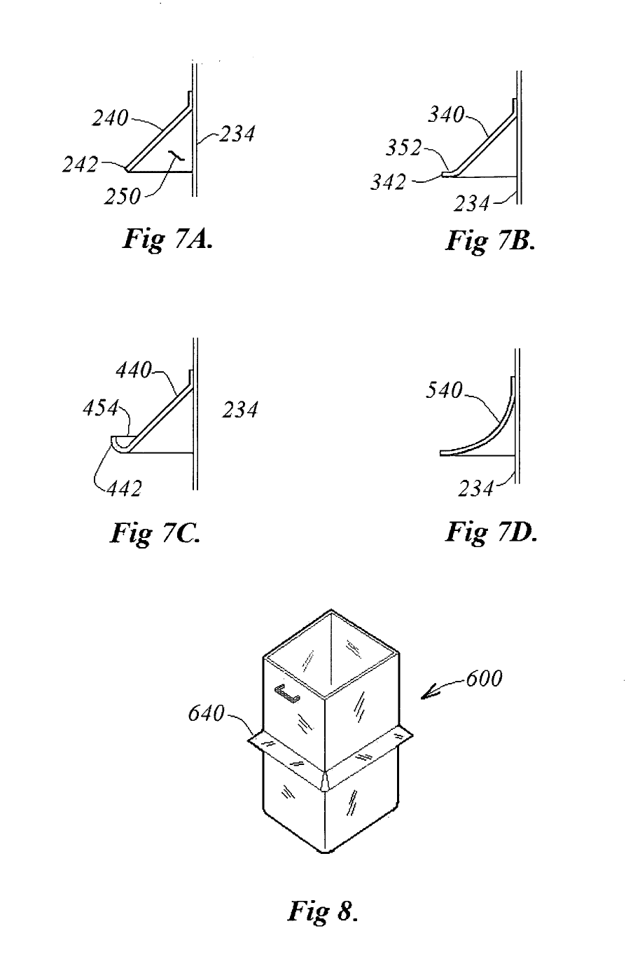

Skirt 240 surrounds peripheral wall 234 about halfway between open top 230 and closed bottom 232 and extends peripherally downwardly and outwardly there-from to an outer peripheral edge 242, as best seen in FIG. 7A. The outer peripheral edge is preferably approximately three inches or more outwardly beyond wall 234, and the downward slope of the skirt is preferably approximately forty-five angular degrees. As can be readily appreciated by comparing prior art FIG. 3 to FIG. 6, skirt 240 of the presently described embodiment of the invention serves to deflect spilled fat 202B away from flame 112 and to thereby prevent its ignition.

Skirt 240 may be permanently affixed or integrally formed with peripheral wall 234, or may be supplied as a separate close-fitting circular component which may be slip up around the pot from below. Alternatively, the skirt may be supplied as a C-shaped ring which is wrapped around the pot and secured to the pot or secured end-to-end to itself to attach to the pot.

An additional advantage of the skirt is realized by its thermal benefit. A peripheral chamber 250 is formed by the skirt and the pot, surrounding the pot, and disposed below the skirt, which retains heat rising from below against the pot. Such a hot zone around the pot improves heating efficiency and allows reduction of the flame intensity. By reducing flame intensity, not only is fuel saved, but the flame size, across tip to tip, is reduced. This shortening of the flame which would have otherwise extended beyond the pot's bottom also reduces the likelihood of inadvertent ignition of spilled fat be retracting the flame tips inwardly from the spilling fat.

FIG. 7B depicts an alternative skirt 340 having a jump-edge 352 adjacent its outer peripheral edge 342 for directing spilled fat further outwardly as it travels down the skirt.

FIG. 7C depicts an alternative skirt 440 having a moat 454 formed adjacent its outer peripheral edge 442 for collecting spilled fat as it travels down the skirt.

FIG. 7B depicts an alternative skirt 540 having a concave-slope for directing spilled fat further outwardly as it travels down the skirt.

FIG. 8 depicts a rectilinear pot 600 having a rectilinear skirt 640. In fact, the invention may be adapted to pots of virtually any shape.

While the invention has been shown and described with reference to specific exemplary embodiments, it should be understood by those skilled in the art that various changes in form and detail may be made without departing from the spirit and scope of the invention, and that the invention should therefore only be limited according to the following claims, including all equivalent interpretation to which they are entitled.

We claim:

1. A deep fat frying apparatus comprising:
a pot having;
an open top,
a closed bottom; and
a peripheral wall surrounding said open top and extending downwardly there-from to and closed by said closed bottom; and
a reservoir for containing a flammable cooking liquid; and
a skirt surrounding said peripheral wall and extending peripherally downwardly and outwardly there-from to an outer peripheral edge; wherein
said outer peripheral edge is outwardly beyond said pot.

2. The apparatus of claim 1 wherein said skirt extends peripherally downwardly and outwardly from said peripheral wall in one of a straight slope, a concaved slope, and a jump-edged slope.

3. The apparatus of claim 2 wherein said outer peripheral edge comprises a peripheral moat.

4. The apparatus of claim 3 further comprising a cooking stand for supporting said pot and providing a cooking flame directed against said closed bottom;

5. The apparatus of claim 4 wherein said flame has outwardly extending flame tips and said outer peripheral edge is outwardly beyond said flame tips.

6. The apparatus of claim 1 wherein said outer peripheral edge is at least approximately three inches outwardly beyond said pot.

7. The apparatus of claim 6 wherein said skirt extends peripherally downwardly and outwardly from said peripheral wall in one of a straight slope, a concaved slope, and a jump-edged slope.

8. The apparatus of claim 7 wherein said outer peripheral edge comprises a peripheral moat.

9. The apparatus of claim 8 further comprising a cooking stand for supporting said pot and providing a cooking flame directed against said closed bottom;

10. The apparatus of claim 9 wherein said flame has outwardly extending flame tips and said outer peripheral edge is outwardly beyond said flame tips.

11. The apparatus of claim 1 further comprising a cooking stand for supporting said pot and providing a cooking flame directed against said closed bottom;

12. The apparatus of claim 11 wherein said flame has outwardly extending flame tips and said outer peripheral edge is outwardly beyond said flame tips.

13. A combination deep fat frying pot and skirt, said pot comprising
an open top,
a closed bottom; and
a peripheral wall surrounding said open top and extending downwardly there-from to and closed by said closed bottom;
a reservoir for containing a flammable cooking liquid; and
said skirt surrounding said peripheral wall and extending peripherally downwardly and outwardly there-from to an outer peripheral edge; wherein
said outer peripheral edge is outwardly beyond said pot.

14. The combination of claim 13 wherein said outer peripheral edge is at least approximately three inches outwardly beyond said pot.

15. The combination of claim 14 wherein said skirt extends peripherally downwardly and outwardly from said peripheral wall in one of a straight slope, a concaved slope, and a jump-edged slope.

16. The combination of claim 15 wherein said outer peripheral edge comprises a peripheral moat.

17. The combination of claim 13 wherein said skirt extends peripherally downwardly and outwardly from said peripheral wall in one of a straight slope, a concaved slope, and a jump-edged slope.

18. A skirt for use in combination with a cooking pot, said skirt comprising:
a shelf extending peripherally downwardly and outwardly from the pot for deflecting outwardly any materials spilled from the pot; and
a peripheral chamber formed by said shelf and the pot, surrounding the pot, and disposed below said shelf, for retaining heat against the pot.

19. The skirt of claim 18 wherein said shelf extends peripherally downwardly and outwardly from the pot in one of a straight slope, a concaved slope, and a jump-edged slope.

20. The skirt of claim 19 wherein said self terminates in an outer peripheral edge comprising a peripheral moat.
